(19) United States
(12) Patent Application Publication
(10) Pub. No.: US 2021/0014623 A1
(43) Pub. Date: Jan. 14, 2021

(54) SPEECH COMMUNICATION MODULE

(71) Applicants: TOYOTA JIDOSHA KABUSHIKI KAISHA, Toyota-shi (JP); DENSO CORPORATION, Kariya-city (JP); YAMAHA CORPORATION, Hamamatsu-shi (JP)

(72) Inventors: Keizoh KAWAGUCHI, Toyota-shi (JP); Ichiro SHIGETOMI, Kariya-city (JP); Kunito TAKAHASHI, Hamamatsu-shi (JP)

(73) Assignees: TOYOTA JIDOSHA KABUSHIKI KAISHA, Toyota-shi (JP); DENSO CORPORATION, Kariya-city (JP); YAMAHA CORPORATION, Hamamatsu-shi (JP)

(21) Appl. No.: 16/980,192

(22) PCT Filed: Mar. 11, 2019
(86) PCT No.: PCT/IB2019/000133

§ 371 Date: Sep. 11, 2020

(30) Foreign Application Priority Data
Mar. 12, 2018 (JP) 2018-044238

(51) Int. Cl. H04R 29/00; H04R 1/02; H04R 3/00

(52) U.S. Cl. CPC H04R 29/001; H04R 1/025; H04R 1/023; H04R 2430/01; H04R 29/004; H04R 2499/13; H04R 3/00

(57) ABSTRACT

A speech communication module that is to be attached in a cabin of a vehicle includes: a microphone; a loudspeaker; and a controller. The controller includes a memory storing a table that information indicating a corresponding relation between an acoustic environment parameter of an interior of the cabin of the vehicle and a vehicle type of the vehicle is stored in individually for each vehicle type. The controller is configured to acquire information indicating the vehicle type of the vehicle that the speech communication module is to be attached to from the vehicle, to read an acoustic environment parameter corresponding to the acquired vehicle type from the table, and to automatically adjust an acoustic parameter of the microphone and the loudspeaker in accordance with the read acoustic environment parameter.

### BACKGROUND OF THE INVENTION

### 1. Field of the Invention

The present invention relates to a speech communication module.

### 2. Description of Related Art

Japanese Patent Application Publication No. 2014-026146 discloses a technology of downloading tuning parameters for adjusting acoustic characteristics of an in-vehicle audio apparatus into a smartphone from a server, and setting the tuning parameters to the audio apparatus via wireless connection between the audio apparatus and the smartphone.

### SUMMARY OF THE INVENTION

With the technology in JP 2014-026146 A, a user holding the smartphone is needed to activate an application program for setting the audio apparatus, and to set information of acoustic environment items such as a vehicle type, the number of loudspeakers and a listening position. Such setting operation is called acoustic tuning. It is not easy for a user not familiar with technical knowledge of acoustic devices such as a loudspeaker and a microphone or with the acoustic tuning to perform the aforementioned acoustic tuning, which occasionally leads to time and labor.

The present invention provides a technology of automatically adjusting acoustic parameters of a speech communication module to be attached to a vehicle.

A speech communication module according to the present invention is a speech communication module that is to be attached in a cabin of a vehicle. The speech communication module includes: a microphone; a loudspeaker; and a controller. The controller includes a memory storing a table that information indicating a corresponding relation between an acoustic environment parameter of an interior of the cabin and a vehicle type of the vehicle is stored in individually for each vehicle type. The controller is configured to acquire information indicating the vehicle type of the vehicle that the speech communication module is to be attached to from the vehicle. The controller is configured to read an acoustic environment parameter corresponding to the acquired vehicle type from the table. The controller is configured to automatically adjust an acoustic parameter of the microphone and the loudspeaker in accordance with the read acoustic environment parameter.

In the aforementioned speech communication module, the acoustic parameter may be a sound volume or an effect.

In the aforementioned speech communication module, the acoustic environment parameter may include a distance between the speech communication module and an occupant to ride in the vehicle in a state where the speech communication module is attached to an overhead console in the cabin of the vehicle.

In the aforementioned speech communication module, the acoustic environment parameter may include an attachment angle of the loudspeaker or an aperture ratio of a grill of the loudspeaker in the state where the speech communication module is attached to the overhead console in the cabin of the vehicle.

In the aforementioned speech communication module, a positional relation between the microphone and the loudspeaker may be fixed.

According to the speech communication module according to the present invention, the acoustic parameter of the speech communication module can be automatically adjusted.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory diagram showing a hardware configuration of a speech communication module according to an embodiment of the present invention; and

FIG. 2 is a graph showing the corresponding relations between a distance between the speech communication module and an occupant to ride in a vehicle and a sound volume of a loudspeaker on the occasion when the speech communication module according to an embodiment of the present invention is attached to an overhead console in a cabin of the vehicle.

### DETAILED DESCRIPTION OF EMBODIMENTS

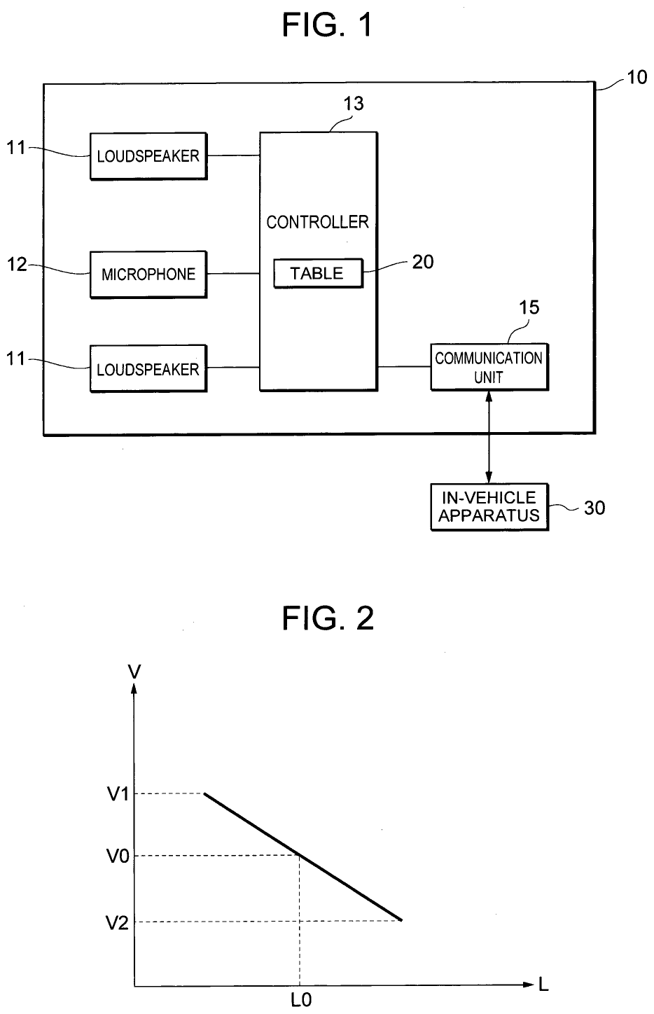

Hereafter, an embodiment of the present invention is described with reference to the drawings. Herein, the same signs denote the same constituent components and their duplicate description is omitted. FIG. 1 is an explanatory diagram showing a hardware configuration of a speech communication module 10 according to an embodiment of the present invention. The speech communication module 10 is a wireless speech communication interface to be attached in a cabin of a vehicle. An occupant of the vehicle can make voice communication with an operator (for example, a person in charge of a traffic accident in a police station, a fire station or an insurance company) using the speech communication module 10, for example, upon an emergency call.

The speech communication module 10 is attached, for example, to an overhead console in the cabin of the vehicle. The overhead console is a console, for a front seat, disposed in a center part of the ceiling of the vehicle. In the overhead console, for example, a map lamp, a clock, an accessory case and the like can be provided.

The speech communication module 10 includes loudspeakers 11, a microphone 12, a controller 13 and a communication unit 15. The controller 13 is a control apparatus including a processor, a semiconductor memory (a volatile memory and/or a nonvolatile memory), a digital signal processor (DSP) and an input-output interface. The DSP performs digital signal processing (for example, equalizer processing) on voice signals passed between the occupant of the vehicle and the operator via the loudspeakers 11 and the microphone 12. The nonvolatile memory in the controller 13 stores a table 20. Details of the table 20 are mentioned later. The communication unit 15 controls transmission and reception of such voice signals passed between the occupant of the vehicle and the operator via a wireless line. An in-vehicle apparatus 30 includes a storage apparatus which stores information indicating a vehicle type of the vehicle that the speech communication module 10 is to be attached to. The communication unit 15 connects to the in-vehicle apparatus 30 via an in-vehicle network, and can acquire the information indicating the vehicle type of the vehicle from the in-vehicle apparatus 30. Notably, the positional relation (in particular, distance) between the microphone 12 and the loudspeakers 11 is fixed.

Voice quality (for example, frequency characteristics, howling, echo and noise) of the speech communication module 10 used for an emergency call is required to satisfy a certain quality standard as its standard. It is known that an acoustic environment of the vehicle cabin of the vehicle is affected by the shape and the size of the vehicle cabin, the materials of accessories therein, and the like. In particular, when the speech communication module 10 in which the positional relation between the microphone 12 and the loudspeakers 11 is fixed is used, the acoustic environment in the cabin of the vehicle largely depends on the positional relation between the speech communication module 10 and the occupant to ride in the vehicle. Based on acoustic environment parameters with which the acoustic environment in the cabin of the vehicle is quantitatively evaluated, the controller 13 automatically adjusts acoustic parameters of the microphone 12 and the loudspeakers 11. Herein, the acoustic environment parameters include the distance between the speech communication module 10 (in particular, each loudspeaker 11) and the occupant to ride in the vehicle in the state where the speech communication module 10 is attached to the overhead console in the cabin of the vehicle. The distance depends on the dimensions of the cabin different for each vehicle type. In the case the distance is long or short, each distance differently affects the voice quality of the speech communication module 10. The acoustic environment parameters may include attachment angles of the loudspeakers 11 in the state where the speech communication module 10 is attached to the overhead console in the cabin of the vehicle. It is known that the attachment angles differently affect the voice quality of the speech communication module 10 depending on the measurements of the attachment angles of the loudspeakers 11. The acoustic environment parameters may include aperture ratios of grills of the loudspeakers 11. It is known that the aperture ratios differently affect the voice quality of the speech communication module 10 depending on the measurements of the aperture ratios of the grills of the loudspeakers 11. Notably, an acoustic parameter is, for example, a sound volume or an effect.

The table 20 stores information indicating the corresponding relations between the acoustic environment parameters of the interior of the cabin of the vehicle and the vehicle type of the vehicle individually for each vehicle type. The controller 13 acquires information indicating the vehicle type of the vehicle that the speech communication module 10 is to be attached to from the in-vehicle apparatus 30 via the communication unit 15, reads acoustic environment parameters corresponding to the acquired vehicle type from the table 20, and automatically adjusts acoustic parameters of the microphone 12 and the loudspeakers 11 in accordance with the read acoustic environment parameters. FIG. 2 is a graph showing the corresponding relations between a distance L between the speech communication module 10 (in particular, each loudspeaker 11) and the occupant to ride in the vehicle and sound volumes V of the loudspeakers 11 in the state where the speech communication module 10 is attached to the overhead console in the cabin of the vehicle. In the figure, sign V1 denotes the maximum sound volume of the loudspeaker 11 which can be allowed based on the standard, and sign V2 denotes the minimum sound volume of the loudspeaker 11 which can be allowed based on the standard. By automatically adjusting the sound volume V0 of the loudspeaker 11 such that the sound volume V0 equals to (V1+V2)/2 on the occasion when the distance L is L0, the sound volumes of the loudspeakers 11 can be optimized in accordance with an acoustic environment parameter distance L0.

Moreover, even with the same distance L, an optimal value of the sound volume V of the loudspeaker 11 is different depending on the attachment angle of the loudspeaker 11 and the aperture ratio of the grill of the loudspeaker 11. The controller 13 may automatically adjust the optimal value of the sound volume V of the loudspeaker 11 in consideration of any one or both of the attachment angle of the loudspeaker 11 and the aperture ratio of the grill of the loudspeaker 11 as well as the distance L. While in the aforementioned description, the sound volume is exemplarily presented as the acoustic parameter, the effect may also be automatically adjusted by the similar method to that for the sound volume. The controller 13 may hold different optimal values of acoustic parameters individually for a plurality of combinations of acoustic environment parameters as map data. By using such map data, automatic adjustment of the acoustic parameters can be simplified.

According to the speech communication module 10 according to an embodiment of the present invention, even when a user is not familiar with technical knowledge of acoustic devices such as the loudspeakers 11 and the microphone 12 or with acoustic tuning, the acoustic parameters of the microphone 12 and the loudspeakers 11 can be automatically optimized.

The embodiment described above is for ease of understanding of the present invention and not for limited construing of the present invention. The present invention can be modified or improved without departing from its spirit, and the present invention also includes its equivalents.

1. A speech communication module that is to be attached in a cabin of a vehicle, the speech communication module comprising:
a microphone;
a loudspeaker; and
a controller including a memory storing a table that information indicating a corresponding relation between an acoustic environment parameter of an interior of the cabin and a vehicle type of the vehicle is stored in individually for each vehicle type, wherein the controller is configured to acquire information indicating the vehicle type of the vehicle that the speech communication module is to be attached to from the vehicle,
the controller is configured to read an acoustic environment parameter corresponding to the acquired vehicle type from the table, and
the controller is configured to automatically adjust an acoustic parameter of the microphone and the loudspeaker in accordance with the read acoustic environment parameter.

2. The speech communication module according to claim 1, wherein the acoustic parameter is a sound volume or an effect.

3. The speech communication module according to claim 1, wherein the acoustic environment parameter includes a distance between the speech communication module and an occupant to ride in the vehicle in a state where the speech communication module is attached to an overhead console in the cabin of the vehicle.

4. The speech communication module according to claim 3, wherein the acoustic environment parameter includes an attachment angle of the loudspeaker or an aperture ratio of a grill of the loudspeaker in the state where the speech communication module is attached to the overhead console in the cabin of the vehicle.

5. The speech communication module according to claim 1, wherein a positional relation between the microphone and the loudspeaker is fixed.
